(19) United States
(12) Patent Application Publication
(10) Pub. No.: US 2020/0355330 A1
(43) Pub. Date: Nov. 12, 2020

(54) Horizontal Hydroponic Farm Compatible Lighting System

(71) Applicant: MJNN, LLC, South San Francisco, CA (US)

(72) Inventors: Kevin Kai Morris, Oakland, CA (US); Grant Thomas Lindblom, South San Francisco, CA (US); John Whitworth, Mountain View, CA (US)

(73) Assignee: MJNN, LLC, South San Francisco, CA (US)

(21) Appl. No.: 16/406,620

(22) Filed: May 8, 2019

(51) Int. Cl. F21K 9/275; F21V 19/00; F21V 17/06; F21V 31/00; A01G 7/04; F16M 13/02

(52) U.S. Cl. CPC F21K 9/275; F21V 19/0015; F21V 17/06; F21Y 2115/10; A01G 7/045; F16M 13/02; F21V 31/005

(57) ABSTRACT

A lighting assembly is provided that is configured for use with a hydroponic farm, preferably a hydroponic farm utilizing horizontal racks. The light assembly includes one or more LED boards affixed to a thermally conductive mounting fixture. The number and location of the LED boards which are mounted to the fixture is primarily dependent upon the size and layout of the hydroponic racks within the hydroponic farming facility. A light shield, which surrounds the LED boards and the mounting fixture, extends the entire length of the light assembly. The light shield is sealed to both light assembly end caps, thereby providing a completely sealed lighting unit.

### FIELD OF THE INVENTION

The present invention relates generally to hydroponic growing systems and, more particularly, to a lighting system configured to provide light to a horizontal hydroponic farm.

### BACKGROUND OF THE INVENTION

Given the continued growth of the world's population, and given that the regions allocated for agricultural pursuits have decreased or simply become less favorable to such activities, the ability of conventional farms to feed the world's growing population has become increasingly taxed. Additionally, since population centers and agricultural centers are frequently not co-located, and due to the time and expense associated with shipping agricultural goods, in many regions of the world only the wealthy are able to obtain adequate supplies of non-processed food, i.e., raw fruits and vegetables. Furthermore, the fruits and vegetables that do reach population centers are likely to be of decreased nutritional content and flavor, both due to the distance that they have traveled and the fact that much of today's produce is bred for durability and fertility rather than flavor & nutrition. As a result, there has been a renewed interest in soilless growing techniques that do not require the use of pesticides, drastically reduce the use of water, and allow for growing varietals that are bred for nutrition and flavor instead of durability.

Hydroponics is a soilless growing technique in which plants are grown using a liquid solution of water and nutrients. The roots of the plants are typically maintained in a fibrous or granular material, often comprised of plastic, and fed via a wick, drip, nutrient film, or other nutrient delivery system. Hydroponic growing systems are often established within indoor facilities, thus allowing them to be located in or near population centers. This approach also provides exceptional climate control (i.e., temperature, humidity, air flow, CO₂ concentration, light wavelength, intensity and duration, etc.) as well as improved pest and disease control, thus allowing an indoor hydroponic farm to succeed in a region in which the outside environment and/or the soil conditions are inhospitable to the use of conventional farming techniques. Furthermore, hydroponic and other soilless growing techniques can yield extremely high plant densities, especially in those instances in which either horizontal stacking systems or vertical growth towers are used.

While hydroponic farming techniques offer a number of advantages over conventional farming techniques, in order to achieve large-scale adoption of these techniques it is vital that the cost per plant be competitive with the costs associated with conventional farming techniques. Accordingly, the present invention provides a hydroponic farm compatible lighting system.

### SUMMARY OF THE INVENTION

A lighting assembly configured for use with a hydroponic growing facility is provided, the lighting assembly including (i) an LED board mounting fixture; (ii) an LED board mounted to the LED board mounting fixture; (iii) a plurality of LEDs attached to the LED board; (iv) a light shield encircling the LED board mounting fixture and the LED board mounted to the LED board mounting fixture, the light shield extending from a first end of the LED board mounting fixture to a second end of the LED board mounting fixture; (v) a first end cap bonded to a first end of the light shield, the first end of the light shield proximate to the first end of the LED board mounting fixture; and (vi) a second end cap bonded to a second end of the light shield, the second end of the light shield proximate to the second end of the LED board mounting fixture, the second end cap including an LED board power connector, wherein a set of HV wires from the LED board pass through the second end cap to the LED board power connector, and wherein the LED board mounting fixture and the LED board are completely bounded by the light shield, the first end cap and the second end cap. Preferably a first water-tight seal is created when the first end cap is bonded to the first end of the light shield, and a second water-tight seal is created when the second end cap is bonded to the second end of the light shield. The light shield may include internal features that align and locate the LED board mounting fixture within the light shield. A layer of a thermally conductive material may be interposed between the LED board and the LED board mounting fixture.

In one aspect of the invention, the lighting system may include a mounting bracket slidably attached to the light shield. The mounting bracket may include a pair of grooves with a first groove of the pair configured to slide along a first edge of a first side of the light shield, and with a second groove of the pair configured to slide along a second edge of a second side of the light shield. The mounting bracket may further include a secondary member configured to lock the mounting bracket into a specific location on the light shield. The secondary member may include a post threadably coupled to the mounting bracket via a threaded thru-hole, where the post in a withdrawn position does not lock the mounting bracket into the specific location on the light shield, and where the post in an extended position extends through the mounting bracket and locks the mounting bracket into the specific location on the light shield. Alternately, the secondary member may include a post and the mounting bracket may include a spring assembly configured to apply a spring load on the secondary member, where the spring load forces the post into an extended position that locks the mounting bracket into the specific location on the light shield, and where the application of a counter force to the secondary member withdraws the post from the extended position and unlocks the mounting bracket from the specific location on the light shield.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. The same reference label on different figures should be understood to refer to the same component or a component of similar functionality. Additionally, multiple labels using the same numerical label and differing only in the letter label (e.g., 301A and 301B) refer to components of the same or similar functionality but positioned in different locations within or on the apparatus.

FIG. 1 provides a perspective view of a mounting fixture configured for use with the preferred embodiment of the lighting system of the invention;

FIG. 2 provides a cross-sectional view of the mounting fixture shown in FIG. 1;

FIG. 3 provides a perspective view of the mounting fixture shown in FIGS. 1 and 2 with an LED board attached to the surface of the fixture;

FIG. 4 provides a top view of a portion of a light assembly, this view illustrating the electrical connectors used to couple two LED boards together on a single mounting fixture;

FIG. 5 provides a simplified cross-sectional view of the light assembly in accordance with the invention;

FIG. 6 provides a simplified cross-sectional view of the light assembly similar to that shown in FIG. 5 with the addition of an end cap;

FIG. 7 provides an end view of the end cap shown in FIG. 6;

FIG. 8 provides the same view as that shown in FIG. 6, this figure including the sealant layer that bonds the end cap to the light shield;

FIG. 9 provides a simplified end view of the second end cap along with a portion of the light shield, mounting fixture and LED board;

FIG. 10 provides an end view of the assembly shown in FIG. 9 without the outer end cap member;

FIG. 11 provides the same view of the assembly as that provided in FIG. 10 with the inclusion of the outer end cap member;

FIG. 12 provides an end view of the outer end cap member of the second end cap;

FIG. 13 provides a simplified cross-sectional view of a light assembly mounting bracket, this view including components of the light assembly;

FIG. 14 provides a simplified cross-sectional view of the light assembly mounting bracket shown in FIG. 13, this view excluding components of the light assembly;

FIG. 15 provides a side view of the light assembly mounting bracket shown in FIGS. 13 and 14;

FIG. 16 provides an alternate side view of the light assembly mounting bracket shown in FIGS. 13-15;

FIG. 17 provides a simplified cross-sectional view of the light assembly mounting bracket, similar to the view provided in FIG. 13 but utilizing a different mounting bracket attachment member;

FIG. 18 provides a simplified cross-sectional view of the light assembly mounting bracket, similar to the view provided in FIGS. 13 and 17 but utilizing a different mounting bracket attachment member;

FIG. 19 provides a front view of an exemplary hydroponic farming facility mounting bracket;

FIG. 20 provides a side view of the exemplary hydroponic farming facility mounting bracket shown in FIG. 19;

FIG. 21 provides a similar view as that of FIG. 20 with the addition of the light assembly of FIG. 13; and

FIG. 22 illustrates an alternate hydroponic farming facility mounting bracket for use with the light assembly of the invention.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

The present invention provides a lighting system that is configured for use with a hydroponic farm, preferably a hydroponic farm utilizing horizontal racks. The primary component of the lighting system is a light assembly, the light assembly including one or more LED boards affixed to a central, thermally conductive, mounting fixture. The LED boards are preferably fixed to a single side of the mounting fixture, where the number and location of the LED boards on the mounting fixture is primarily dependent upon the size and layout of the hydroponic racks within the hydroponic farming facility. A light shield, which surrounds the LED boards and mounting fixture, extends the entire length of the light assembly. The light shield is sealed, as described in detail below, to both light assembly end caps, thereby providing a completely sealed light assembly. A flexible mounting system is used to locate each light tube within the hydroponic farming facility.

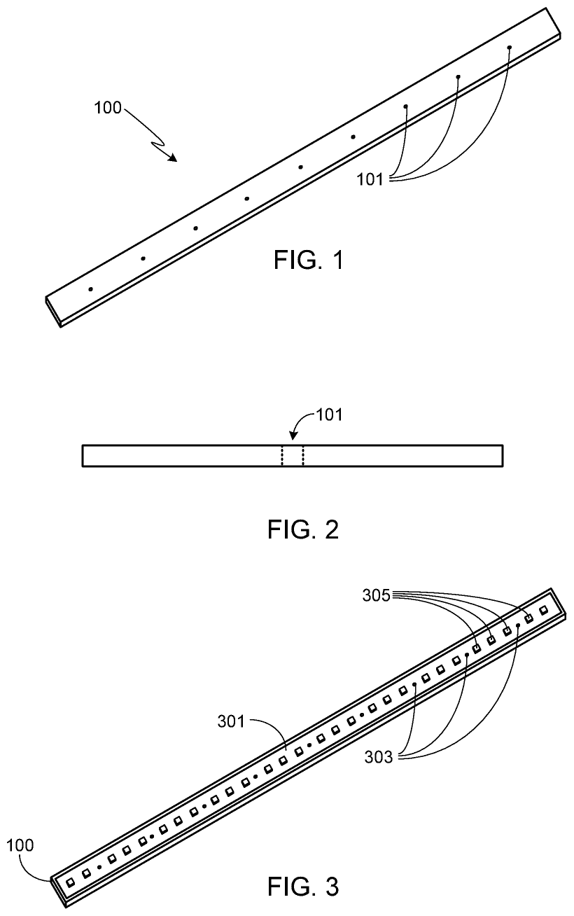

FIGS. 1 and 2 provide perspective and cross-sectional views, respectively, of a preferred configuration for the LED board mounting fixture 100. Fixture 100 is fabricated from a material with a relatively high thermal conductivity and, in the preferred embodiment, is fabricated from aluminum. Preferably mounting fixture 100 is manufactured using an extrusion process. Holes 101, which are preferably threaded, provide a means for mounting the LED board(s) to the fixture. FIG. 3 provides a perspective view of mounting fixture 100 with an LED board 301 fixed to its surface. A plurality of screws 303 attaches LED board 301 to the surface of mounting fixture 100. This view also shows a series of LEDs 305 mounted to the LED board.

In addition to providing a mounting surface for the LED boards comprising the light assembly, mounting fixture 100 also provides an effective heat sink for the heat generated by the LED board(s). To improve thermal communication between the back surface of the LED board(s) and mounting fixture 100, a layer of a thermally conductive medium (not visible in the figures) may be located between the LED board(s) and the mounting surface of the fixture. A double-sided, thermally conductive tape may be used for this purpose, although it should be understood that other thermally conductive media, such as thermally conductive paste, may be used to provide a preferential heat-transfer path between the LED light board(s) and fixture 100.

Depending upon the desired overall length of the light assembly, multiple LED boards may be attached to a single mounting fixture. Alternately, one or more mounting fixtures, each with one or more LED boards, may be combined into a single light assembly in order to achieve the desired light assembly length.

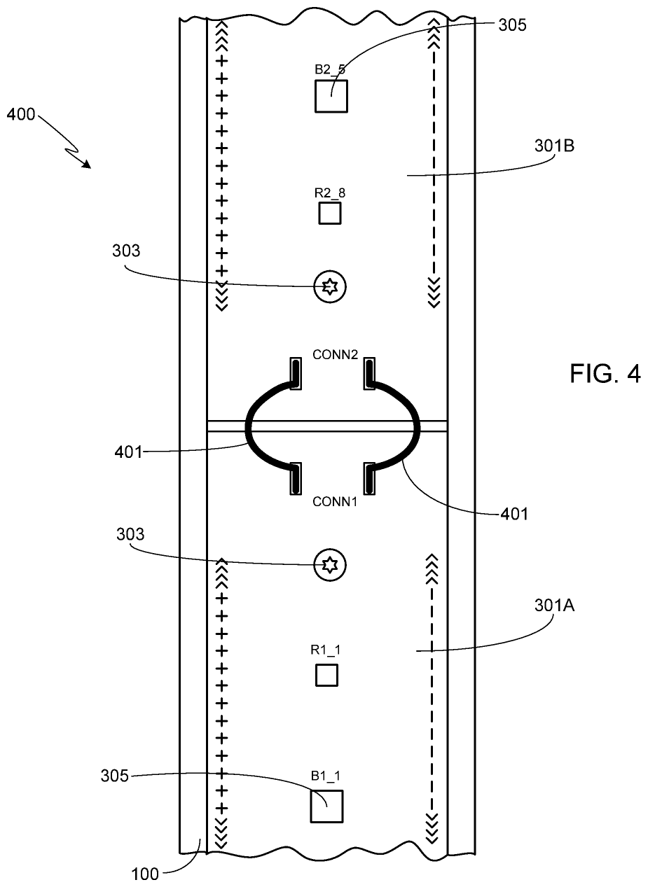

FIG. 4 provides a top view of a portion 400 of a light assembly. In the illustrated view, a portion of a first LED board 301A and a portion of a second LED board 301B are visible. In addition to LEDs 305, this figure clearly illustrates the connectors 401 that electrically couple the two LED boards together. Electrical connectors 401 may be rigid or flexible.

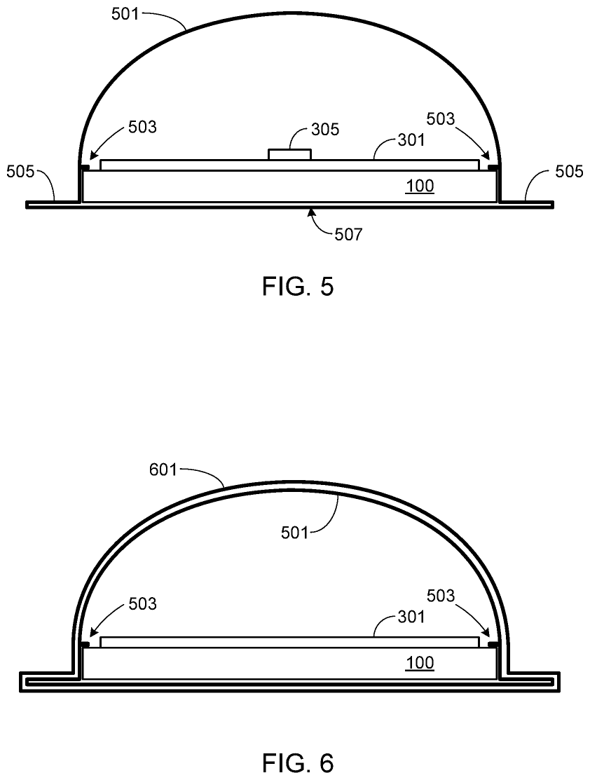

Given the environment of a hydroponic farm, the light assembly of the invention includes a clear tube that surrounds the LED light board(s) as well as the mounting fixture. FIG. 5 provides a cross-sectional view of the mounting fixture 100, an LED board 301, and a light shield 501. An LED 305 is also visible in this figure. Light shield 501 extends the entire length of the light assembly and is sealed, as described in detail below, to both light assembly end caps. Preferably light shield 501 includes internal features 503 that are used to locate mounting fixture 100 and the attached LED board(s) within the light shield. As light shield 501 is preferably a single piece of material as illustrated, internal features 503 allow the mounting fixture with attached LED board(s) to be slid into proper position via one end of the shield prior to affixing the end caps. Shield 501, which is preferably fabricated as a single piece from a plastic material (e.g., acrylic, polycarbonate, etc.), performs several important functions. First, it prevents moisture, dirt or other contaminants (e.g., plant nutrient solution) from contacting, contaminating and/or potentially damaging the electronic components within the light assembly. Second, it simplifies light tube handling. Third, it prevents someone from being harmed by accidentally touching a high voltage light component.

In the preferred embodiment, light shield 501 is clear and is used solely for protection as noted above. The inventors, however, envision that shield 501 can be treated to provide secondary benefits such as light control (e.g., focusing or diffusing the light emitted by the LEDs) and/or wavelength control (e.g., filtering the light emitted by the LEDs to provide a selective light spectrum). In the preferred embodiment, light and wavelength control is provided through selection of specific LEDs that emit the desired light spectrum and light spread (e.g., via LED lenses).

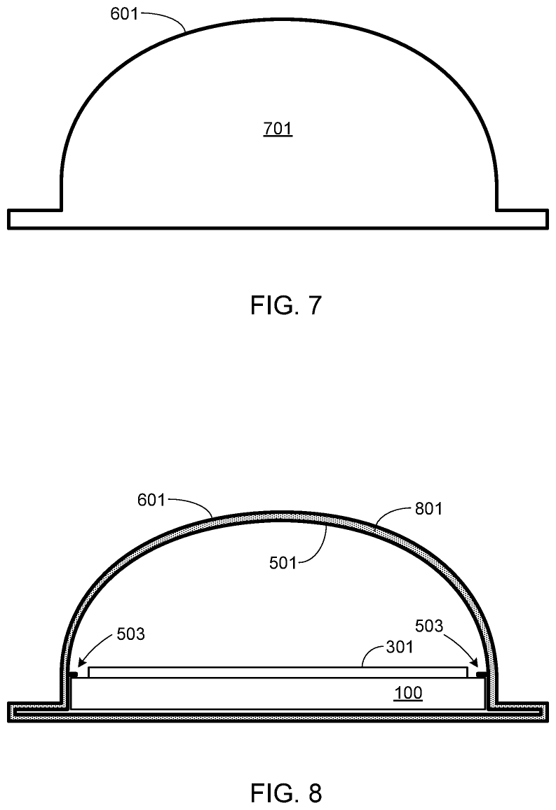

FIG. 6 provides a cross-sectional view of a first end cap 601 along with mounting fixture 100, LED board 301, and light shield 501. FIG. 7 provides an end view of end cap 601, this view illustrating that the end surface 701 of end cap 601 is solid. FIG. 8 provides the same view as that provided by FIG. 6 with the inclusion of a layer 801 of adhesive. Adhesive layer 801 bonds end cap 601 to light shield 501, the adhesive bond creating a water-tight seal between shield 501 and the end cap 601. End cap 601 is preferably fabricated from plastic.

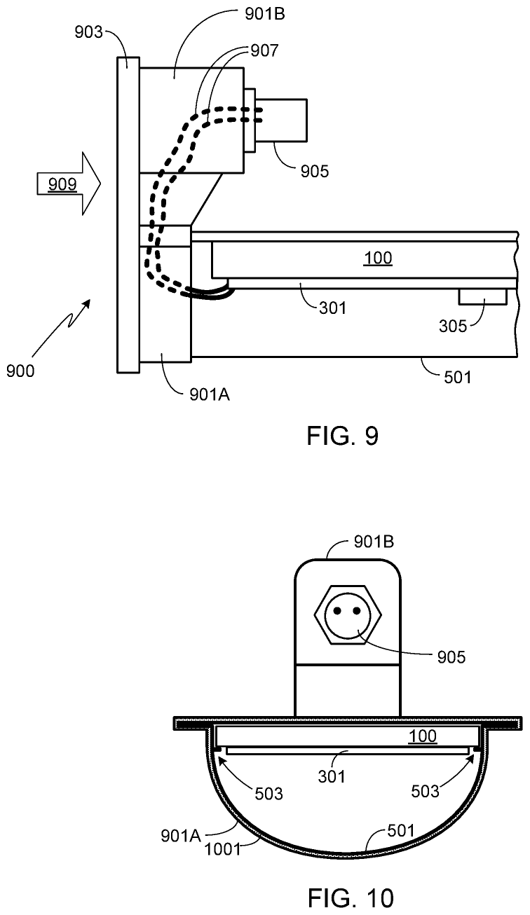

FIG. 9 provides a side view of a second end cap 900, this end cap utilizing a two piece design. End cap 900, which is preferably fabricated from plastic, consists of a first piece 901 and a second piece 903. Even though the first piece 901 of the second end cap is preferably fabricated as a single piece component, in the preferred embodiment it includes a first portion 901A that is configured to accept the end of light shield 501, and a second portion 901B to which LED power connector 905 is attached. The power leads 907 connect the LED board(s) 301 to the LED power connector 905, connector 905 providing means for coupling the LED board(s) to the LED power supply. FIG. 10 provides an end view of the second end cap along with mounting fixture 100, LED board 301 and light shield 501. For clarity this figure only shows piece 901 of the second end cap. Adhesive layer 1001 bonds end cap portion 901A to light shield 501, the adhesive bond creating a water-tight seal between shield 501 and the end cap.

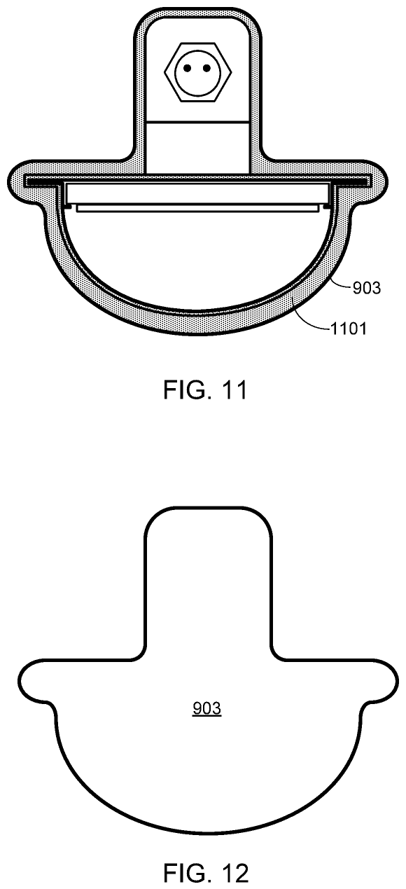

FIG. 11 shows the same view of the assembly as provided in FIG. 10, this view including end cap portion 903. End cap portion 903 is bonded to end cap 901 via adhesive layer 1101, adhesive layer 1101 sealing the two pieces of the second end cap together in order to create a water-tight seal. FIG. 12 provides an end view of end cap portion 903, this view taken from direction 909.

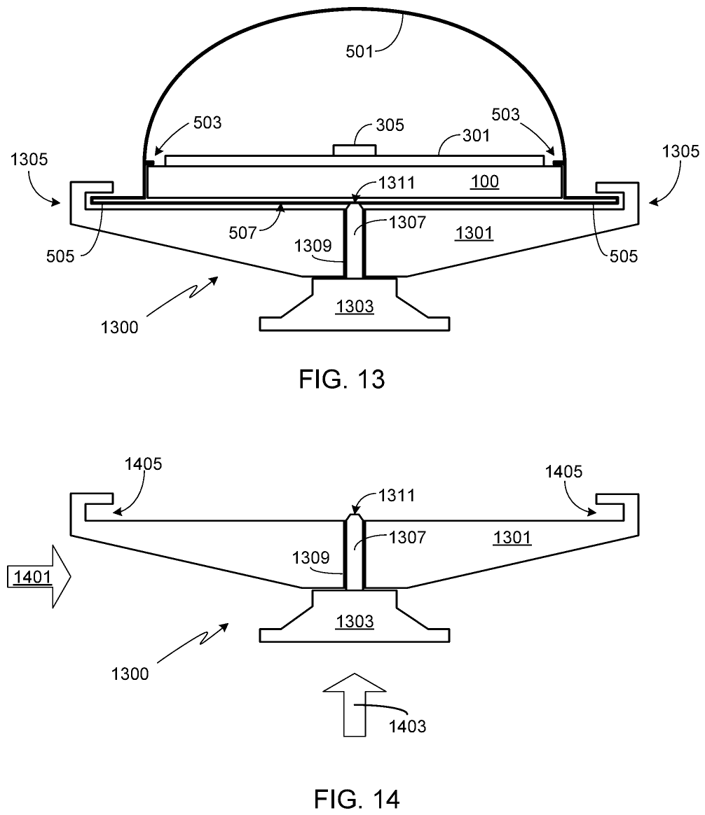

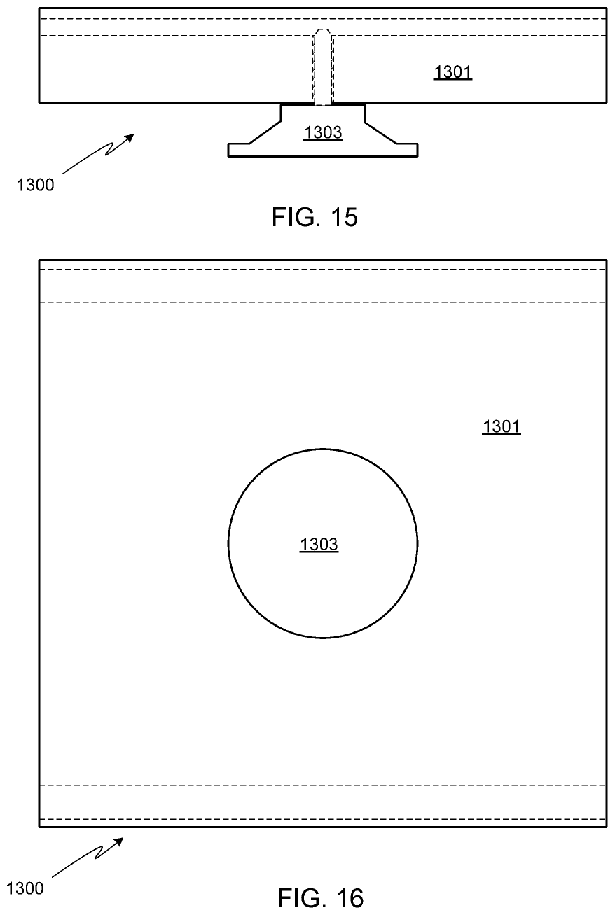

In the preferred embodiment of the invention, one or more mounting brackets are attached to the light assembly, thereby simplifying attachment of the light assembly to the hydroponic farm facility. FIGS. 13 and 14 provide simplified cross-sectional views of light assembly mounting bracket 1300, shown with and without the light assembly, respectively. FIGS. 15 and 16 provide two different side views of light mount 1300 without the light assembly, FIG. 15 taken from direction 1401 and FIG. 16 taken from direction 1403. In the preferred embodiment light assembly mounting bracket 1300 includes a primary member 1301 that is attached to the light assembly and a secondary member 1303 that is attached to primary member 1301, secondary member 1303 providing a simple means of attaching the light assembly to a suitably shaped mount.

The sides 1305 of mounting bracket primary member 1301 are shaped to capture the edge 505 of light shield 501. As shown in the figures, each side 1305 of member 1301 includes a groove 1405 into which light shield edge 505 fits, this configuration allowing mounting bracket 1300 to slide along the length of the light assembly. Due to this edge capturing feature of the mounting bracket, primary bracket member 1301 must either be slid onto the light shield prior to bonding both end caps to the light shield, or member 1301 must be sufficiently pliable that it may be slightly deformed thereby allowing it to be placed on the light shield after the end caps have been bonded to the light shield.

Secondary bracket member 1303 preferably serves multiple purposes. First, it can be used to lock mounting bracket 1300 into a specific location on the light assembly. Second, member 1303 provides a convenient means to attach the mounting bracket to a suitably shaped bracket located in the hydroponic farm. It will be understood that member 1303 can be configured to perform either, or both, of these functions.

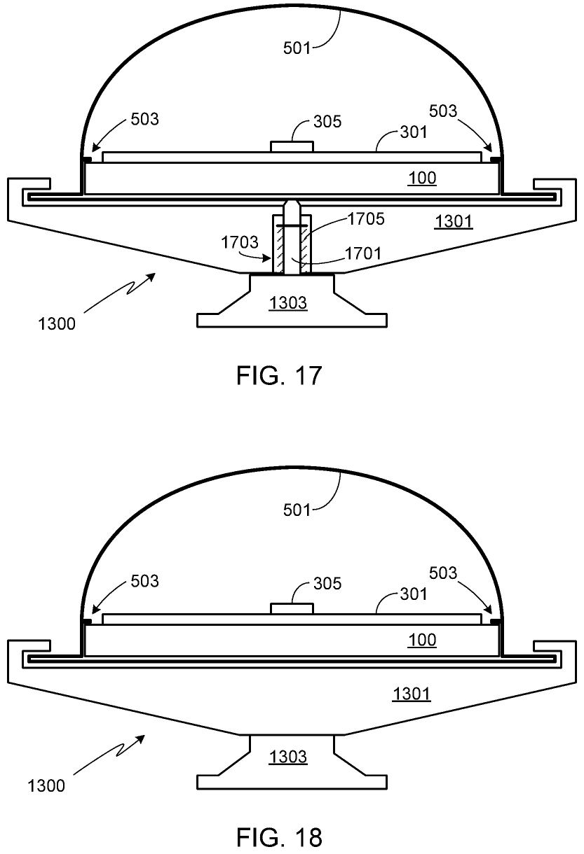

In the preferred embodiment, attached to secondary bracket member 1303 is a threaded post 1307. Threaded post 1307 is threadably coupled to a threaded thru-hole 1309 located in primary bracket member 1301. In this configuration when member 1303 is screwed completely through thru-hole 1309, the end surface 1311 of post 1307 is pressed against the back surface 507 of light shield 501, thereby locking mounting bracket 1300 in place. The inventors envision other bracket configurations that may be used to lock mounting bracket 1300 in place relative to light shield 501. For example and as shown in FIG. 17, post 1701 of secondary member 1303 may be mounted to primary member 1301 via a spring assembly 1703. Spring assembly 1703 applies force to post 1701 such that it is forced into contact with light shield surface 507. In this configuration by varying the spring constant of the spring within spring assembly 1701, the amount of force applied to light shield surface 507 can be controlled. In yet another configuration, in the assembly shown in FIG. 18 secondary bracket member 1303 is rigidly coupled to primary bracket member 1301. As a consequence of this approach mounting bracket 1300 is free to slide along light shield 501, only hindered by the friction between grooves 1405 and light shield edges 505.

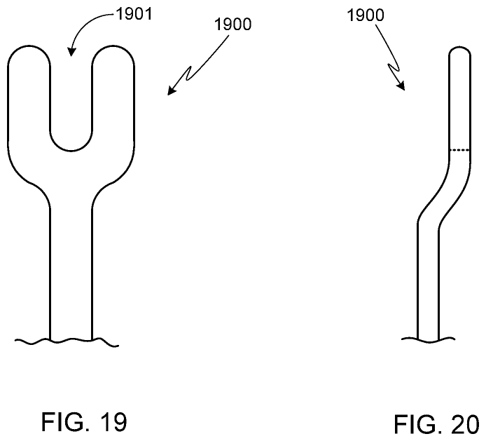

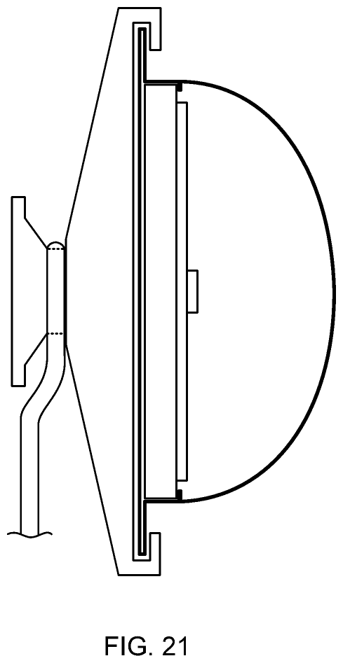

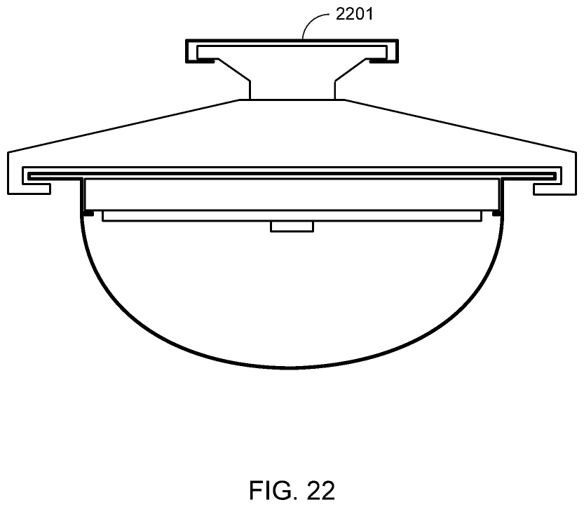

Preferably the light assembly of the invention uses one or more light assembly mounting brackets 1301/1303 to attach to a suitably configured hydroponic farming facility mounting bracket. FIGS. 19 and 20 provide front and side views of an exemplary hydroponic farming facility mounting bracket 1900. FIG. 21 provides a similar view as that of FIG. 20 with the addition of the light assembly of FIG. 13. As shown, hydroponic farming facility mounting bracket 1900 includes a slot 1901 that is sized to accommodate the light assembly mounting bracket 1301/1303. It should be understood that the light assembly mounting configuration shown in FIGS. 19-21 is but one exemplary configuration and that the light assembly of the invention can utilize other mounting configurations. For example, FIG. 22 illustrates an alternate configuration in which the light assembly is hung from a rail mount 2201, rail mount 2201 allowing the light assembly to be slid into alternate positions within the farming facility via the rail mount.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

1. A lighting assembly configured for use with a hydroponic growing facility, the lighting assembly comprising:
an LED board mounting fixture;
an LED board mounted to said LED board mounting fixture;
a plurality of LEDs attached to said LED board;
a light shield encircling said LED board mounting fixture and said LED board mounted to said LED board mounting fixture, said light shield extending from a first end of said LED board mounting fixture to a second end of said LED board mounting fixture;
a first end cap bonded to a first end of said light shield, said first end of said light shield proximate to said first end of said LED board mounting fixture;
a second end cap bonded to a second end of said light shield, said second end of said light shield proximate to said second end of said LED board mounting fixture, said second end cap including an LED board power connector, wherein a set of high voltage (HV) wires from said LED board pass through said second end cap to said LED board power connector, and wherein said LED board mounting fixture and said LED board are completely bounded by said light shield, said first end cap and said second end cap; and
a mounting bracket slidably attached to said light shield, said mounting bracket including a pair of grooves, wherein a first groove of said pair of grooves is configured to slide along a first edge of a first side of said light shield, and wherein a second groove of said pair of grooves is configured to slide along a second edge of a second side of said light shield, said mounting bracket further comprising a secondary member configured to lock said mounting bracket into a specific location on said light shield.

2. (canceled)

3. (canceled)

4. (canceled)

5. The lighting assembly of claim 1, said secondary member further comprising a post threadably coupled to said mounting bracket via a threaded thru-hole, wherein said post in a withdrawn position does not lock said mounting bracket into said specific location on said light shield, and wherein said post in an extended position extends through said mounting bracket and locks said mounting bracket into said specific location on said light shield.

6. The lighting assembly of claim 1, said secondary member further comprising a post, said mounting bracket further comprising a spring assembly configured to apply a spring load on said secondary member, wherein said spring load forces said post into an extended position that locks said mounting bracket into said specific location on said light shield, and wherein applying a counter force to said secondary member withdraws said post from said extended position and unlocks said mounting bracket from said specific location on said light shield.

7. The lighting assembly of claim 1, wherein a first water-tight seal is created when said first end cap is bonded to said first end of said light shield, and wherein a second water-tight seal is created when said second end cap is bonded to said second end of said light shield.

8. The lighting assembly of claim 1, further comprising a layer of a thermally conductive material interposed between said LED board and said LED board mounting fixture.

9. The lighting assembly of claim 1, said light shield further comprising internal features that align and locate said LED board mounting fixture within said light shield.
